(19) United States
(12) Patent Application Publication
(10) Pub. No.: US 2012/0130768 A1
(43) Pub. Date: May 24, 2012

(54) WORK FORCE PLANNING ANALYTICS SYSTEM

(75) Inventors: Geetha RAJAGOPAL, New Delhi (IN); Mousumi ROY, Mumbai (IN); Akhtar JALALUDHEEN, New Delhi (IN); Aastha MANCHANDA, Gurgaon (IN)

(73) Assignee: Accenture Global Services Limited, Dublin (IE)

(21) Appl. No.: 13/282,932

(22) Filed: Oct. 27, 2011

(30) Foreign Application Priority Data
Nov. 19, 2010 (IN) 3472/CHE/2010

(51) Int. Cl. G06Q 10/06

(52) U.S. Cl. 705/7.25

(57) ABSTRACT

A system is disclosed which is configured to perform work force planning analytics for an organisation having an organisational structure and a work force. The system includes a processing module configured to receive input parameters for determining a work force demand, including a definition of the organisational structure and one or more of a productivity metric, a utilization metric, a determining factor metric and a desired span of control metric. The processing module is also configured to receive one or more input parameters for determining a work force supply, including an input of the work force. The system also includes an analytics module, executed by a processor, configured to determine a forecast work force gap utilizing the input parameters for determining a work force demand and supply. The system also includes a user interface configured to provide a view of the forecast work force gap.

### BACKGROUND

Management of an organisation's work force has become increasingly important for it to achieve corporate success. While many factors influence an organisation's ability to achieve high performance, none may be more important than the management of its work force. Technology, organisational strategy, and the development of innovative new products and services are all important. However, it is an organisation's work force which drives it forward, enabling the organisation to translate its projects and goals into products and results. Accordingly, the effective planning for changes to the work force in an organisation is important in helping the organisation to reach its goals, either long-term or short-term.

Nevertheless, effective planning for work force management has become increasingly difficult due to the growing complexity of organisational structures in the modern economy. In addition, highly trained or skilled individuals, those which are most sought by organisations for employment purposes are often in great demand, world-wide, and tend to resign and/or relocate to join work forces at competing organisations with great fluidity. Furthermore, the volatile nature of internal and external forces upon organisational work forces, such as economic conditions and/or changes in the labor market, present multiple impediments to accomplishing precise, accurate and efficient work force planning which a modern organisation needs to operate competitively in the modern worldwide economy.

### BRIEF SUMMARY OF THE INVENTION

A first embodiment is directed to a system configured to perform work force planning analytics for an organisation having an organisational structure and a work force. The system includes a processing module configured to receive input parameters for determining a work force demand, including a definition of the organisational structure and one or more of a productivity metric, a utilization metric, a determining factor metric and a desired span of control metric. The processing module is also configured to receive one or more input parameters for determining a work force supply, including an input of the work force. The system also includes an analytics module, executed by a processor, configured to determine a forecast work force gap utilizing the input parameters for determining a work force demand and supply and a user interface configured to provide a view of the forecast work force gap.

A second embodiment is directed to a system configured to perform work force planning analytics for an organisation having an organisational structure and a work force. The system includes a processor configured to receive input parameters for determining a work force demand, including a definition of the organisational structure and one or more of a productivity metric, a utilization metric, a determining factor metric and a desired span of control metric. The processor is also configured to receive one or more input parameters for determining a work force supply, including an input of the work force, and determine an output of a forecast work force gap utilizing the input parameters for determining a work force demand and supply. The system also includes a storage device configured to store the input parameters for determining the work force demand and supply, and the output of a forecast work force gap. The system also includes a user interface configured to provide a view of the forecast work force gap.

A third embodiment is directed to a method of performing work force planning analytics for an organisation having an organisational structure and a work force. The method includes receiving input parameters for determining a work force demand, including a definition of the organisational structure and one or more of a productivity metric, a utilization metric, a determining factor metric and a desired span of control metric. The method also includes receiving one or more input parameters for determining a work force supply, including an input of the work force. The method also includes determining, by a computer, an output of a forecast work force gap utilizing the input parameters for determining a work force demand and supply.

A fourth embodiment is directed to a non-transitory computer readable medium storing computer readable instructions that when executed by a computer system perform a method of performing work force planning analytics for an organisation having an organisational structure and a work force. The method includes receiving input parameters for determining a work force demand, including a definition of the organisational structure and one or more of a productivity metric, a utilization metric, a determining factor metric and a desired span of control metric. The method also includes receiving one or more input parameters for determining a work force supply, including an input of the work force. The method also includes determining, by a computer, an output of a forecast work force gap utilizing the input parameters for determining a work force demand and supply.

### BRIEF DESCRIPTION OF DRAWINGS

Embodiments are described in detail in the following description with reference to the following figures.

FIG. 1A illustrates a work force planning (WFP) analytics flow diagram 10, according to an embodiment;

FIG. 1B illustrates a WFP analytics system 100, according to an embodiment;

FIGS. 2A through 2H illustrate different screen shots of a user interface 106 in the WFP analytics system 100 shown in FIG. 1B, according to an embodiment;

FIGS. 3A and 3B illustrate methods for performing WFP analytics using the WFP analytics system 100 shown in FIG. 1B, according to two embodiments; and

FIG. 4 illustrates a computer system 400 configured to provide a hardware platform for using the WFP analytics system 100 shown in FIG. 1B, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent however, to one of ordinary skill in the art, that the embodiments may be practiced without limitation to these specific details. In some instances, well known methods and structures have not been described in detail so as not to unnecessarily obscure the embodiments. Furthermore, different embodiments are described below. The embodiments may be used or performed together in different combinations.

### 1. Overview

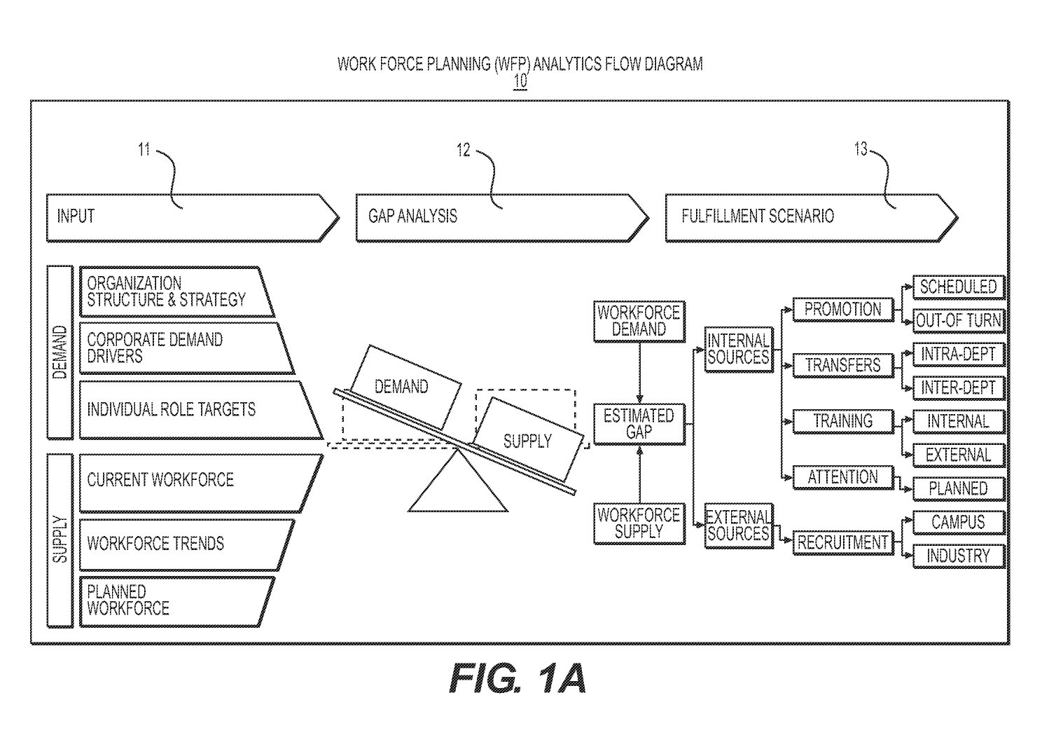

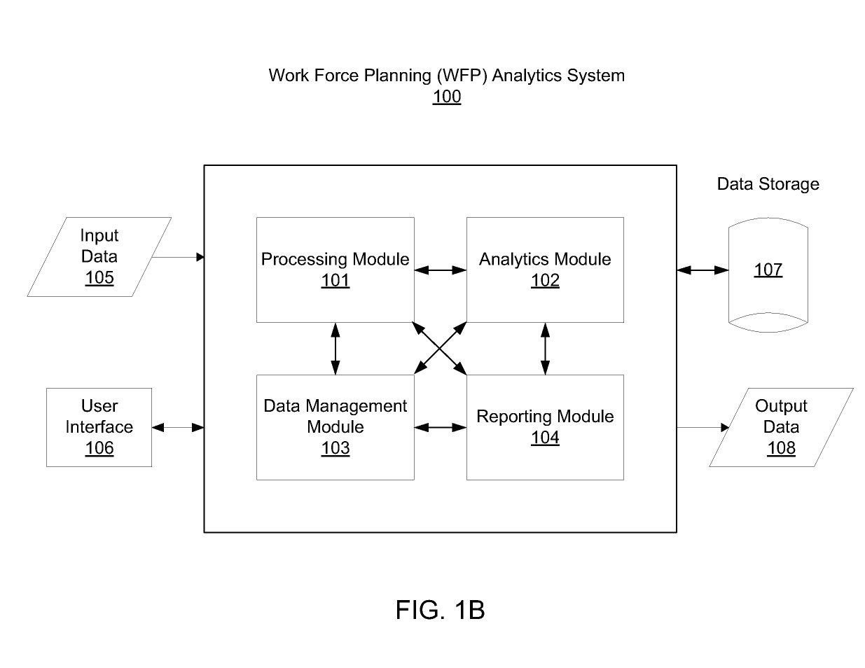

A WFP analytics system, such as the WFP analytics system 100 illustrated in FIG. 1B, enables it's users to effectively perform precise, accurate and efficient WFP analytics for an organisation according to different embodiments, either long-term or short-term, based on the organisation's current or projected organisational structure and/or current or projected work force. In performing WFP analytics, according to an embodiment, the WFP analytics system 100 utilizes input parameters for determining a work force demand and supply to determine a forecast of a work force gap. A work force gap may indicate either a deficit or a surplus in a work force demand or supply. According to an embodiment, the input parameters may be based on horizontal organisational divisions between different functional areas of the organisation and/or on vertical organisational divisions between different responsibility levels.

The WFP analytics system 100 utilizes input parameters. According to an embodiment, the input parameters may be based on individual work force members having one or more horizontal roles in one or more functional areas, one or more vertical roles in one or more responsibility levels, and/or a plurality of horizontal and vertical roles. The input parameters enhance both the accuracy and the precision of the WFP analytics estimates for the forecasting of work force gaps produced using the WFP analytics system 100. The input parameters may enable WFP analytics system users to perform gap analysis calculations based on work force members being involved at either a managerial level and/or a production level in one or more functional divisions of the organisation and/or in an organisational project. In addition, the utilization of the above-described input parameters enables WFP analytics system users to define and implement higher level input parameters for use in the WFP analytics system 100 to further enhance the accuracy and precision of the estimates produced by the WFP analytics system 100. Exemplary higher level input parameters, which are described in greater detail below, include a determining factor metric, a desired span of control metric, a utilization metric, and a productivity metric.

In general, WFP analytics can be described as the process of analyzing work force demand and work force supply and ascertaining one or more work force gaps. A work force gap is a calculated deficit or surplus in the work force membership. Work force gaps may be estimated to occur in one or more functions, sub-functions or positions in the organisation. The work force gaps are then taken into consideration in devising mitigation strategies to attain a balance in the work force so the work force needs of an organisation are fully met in a planned for manner. The demand side of the WFP analytics analysis may take into consideration the governing economic factors, the organisation's structure and business strategy, including corporate demand drivers and targets for individual roles in the organisation. The supply side of the WFP analytics analysis may take into consideration the organisation's current work force or projected work force, current or projected work force trends and planned for additions/deletions to the work force, recruitment, attrition, promotions, etc. WFP analytics may be used to determine planned for work force needs and fulfillment scenarios based on the available or projected demand and supply in the work force for an organisation.

An exemplary organisation in a WFP analytics analysis is pyramidal and hierarchical based on management and executive oversight of the functional areas and/or projects of an organisation. According to an embodiment, an organisation may include a single strategic business unit (SBU) operating within an overall corporate identity. The SBU may be distinguishable from other business units in the corporate identity because it serves a defined external market. The SBU management may conduct strategic planning in relation to the products or services for the SBU external market. A very large corporate identity can include a plurality of SBUs. Each SBU may include one or more functions. A function is a unit in an organisational hierarchy just below an SBU. The function operates in a functional area of the organisation, such as accounting, finance, human resources or marketing. Functions may also operate in a functional area associated with a product or service. A sub-function is a unit in the organisational hierarchy just below a function, such as accounts receivable and accounts payable, which are common sub-functions to an accounting function.

A determining factor metric is a higher level input parameter that may be used to enhance the accuracy and precision of the WFP analytics system 100. Often times, a manager or an executive in an organisation operates in two or more functional or sub-functional areas of an organisation. In addition, a manager may often operate only part-time in a managerial role at one level (e.g., functional or sub-functional) and, at the same time, is also responsible for some non-managerial line responsibility, such as might be associated with the direct delivery of goods or services. This sharing of roles at different levels is a split of responsibility between delivery activities (e.g., activities for the delivery of goods and/or services) and managerial activities. A higher level input parameter which may be used to define this split is the determining factor metric. This may be one of the higher level parameters noted above and may be used to enhance the accuracy and precision of the WFP analytics system 100.

A desired span of control metric is another higher level input parameter that may be used to enhance the accuracy and precision of the WFP analytics system 100. The desired span of control is a ratio defined for a role or a unique position in the organisation. The desired span of control for a role is related to a current span of control. The current span of control for a role is associated with the current workforce strength reporting to the role at one organization hierarchy level. The span for the role is the number of subordinates to a position having the role. The current span is the amount or ratio of subordinates currently associated with the role. A desired span is what the span of control may be for the role after a desired expansion or contraction of the current span.

The desired span of control can be provided as an input parameter in the WFP analytics system 100. As an example, in a current work force for an exemplary organisation, there are 6 sales managers and each sales manager has a current span of 6 sales associates. The current span is 1 to 6 for the sales manager position. If the desired span of control for the sales manager position is 10, then the desired span of control for a single sales manager position is 1 to 10. If the organisation projects having 10 sales manager positions, then the desired span of control for all 10 sales manager positions is 100 sales associates.

A utilization metric is another higher level input parameter that may be used to enhance the accuracy and precision of the WFP analytics system 100. The utilization metric can be defined as the organizational work force buffer, which an entity reserves for unanticipated work force demand and/or other situations that may require an extra work force, such as for an unanticipated project. This may be calculated at a ratio over and above the work force demand when the entity is operating at full capacity. While calculating the utilization metric, a percentage loading factor is added to the work force demand amount which is otherwise calculated as if the entity is operating at full capacity. A simplified example of a utilization metric calculation is when an organisation desires to maintain a buffer of 10% extra work force members for the whole organisation having a current work force of 100 and with a projected work force of 120 in the current year plus 1. In this example, the loading factor may be 10%×120, which is 12 for a utilization of 10% in the current year plus 1.

In the absence of a utilization metric input parameter, work force member involvement in a position is generally assumed as 100%. But this does not account for things like sick leave, maternity leave or any other situations in which work force members may not be available to perform. The utilization metric is often considered in services organisations which keep a bench of non-utilized employees to provide a pipeline for future projects or engagements.

A productivity metric is another higher level input parameter that may be used to enhance the accuracy and precision of the WFP analytics system 100. The productivity metric operates to quantify the productivity that may be associated with individual work force members, roles, unique positions, sub-functions, etc. A simplified example may be a number of widgets produced per day per work force member. Another example may be a number of products sold or total sales amount in values per time period by a work force member. The productivity metric, also known as a demand driver metric, can be any measure of productivity that is translatable to work force requirements.

The overall WFP analytics process is illustrated, according to an embodiment, through the WFP analytics flow diagram 10 shown in FIG. 1A. The WFP analytics process may begin with input 11, including demand inputs and supply inputs for the work force. Demand inputs include the organisation structure, strategy, demand drivers and other demand inputs. Supply inputs that may affect supply can include current work force, work force trends, planned work force modifications and other supply inputs. A gap analysis 12 may then be performed to determined any estimated gaps and/or surpluses. Gaps and/or surpluses may be estimated to occur in one or more functions, sub-functions or positions.

Once the estimated gaps/surpluses are determined, one or more fulfillment scenarios 13 may be devised that may utilize internal and/or external sources to achieve the planned work force balance. Internal sources may include promotions which might be scheduled and/or performed out of turn, transfers from within or among functions and or sub-functions in an organisation, training which can be performed internally or externally and planned for attrition. External sources can include recruitment, such as may be performed on campuses for entry level recruits or in industry for more experienced recruits.

### 2. System

FIG. 1B illustrates a WFP analytics system 100, according to an embodiment. The WFP analytics system 100 includes a processing module 101, an analytics module 102, a data management module 103, a reporting module 104, a user interface 106 and a data storage 107. The WFP analytics system 100 receives input data 105, generally, through the processing module 101, and transmits output data 108, generally, through the reporting module 104.

The WFP analytics system 100 may receive input data 105. The input data 105 may be actual data of, for example, a current work force or a projected work force. The input 105 may also include inputs described with respect to input 11 in FIG. 1A. The input 105 may also include input parameters utilized in the WFP analytics system 100 for processing the input data 105 from the data sources. An input parameter, in general, may be a variable or function that is associated with a specific value during the execution of a program or of a procedure within the WFP analytics system 100.

Input data 105 may include an input of a definition of the current or projected organisational structure, an input of a current or projected work force, an input of a work force demand which is different than the organisational structure and an input of a work force supply which is different than the work force. The input data 105 of the work force and the definition of the organisational structure can be entered manually or downloaded from an automated source, such as enterprise resource planning (ERP) system utilized by the organisation. The input data 105 of the input parameters of the work force demand and the work force supply may be entered manually by the users of the WFP analytics system 100, as is explained in greater detail below.

According to an embodiment, the input of the definition of the organisational structure or the work force, or the output of the forecast work force gap can include input parameters based on horizontal organisational divisions between different functional areas and vertical organisational divisions between different responsibility levels. According to another embodiment, the input of the work force, the work force supply or the work force demand may include parameters based on individual work force members having one or more horizontal roles in one or more functional areas, one or more vertical roles in one or more responsibility levels, or a plurality of horizontal and vertical roles.

According to another embodiment, an input of a prior work force can be input to help define the work force demand. The prior work force data can be used to forecast work force trends. According to another embodiment, an input of an organisational life-cycle stage can be input to define the work force demand. The organisational life-cycle stage can be used to forecast the rate of change and work force member movement within and outside the organisation.

Input data 105 including input parameters may be parameters based on horizontal organisational divisions between different functional areas and vertical organisational divisions between different responsibility levels. Input data 105 that are input parameters can also include parameters based on individual work force members having one or more horizontal roles in one or more functional areas, one or more vertical roles in one or more responsibility levels, or on individual work force members having a plurality of horizontal and vertical roles. The input data 105 of the input parameters may be entered manually by the users of the WFP analytics system. In addition, some or all of the input data 105 associated with the parameters can be downloaded from an automated source, such as may be stored in an ERP system utilized by the organisation. Higher level parameters which may be utilized as input data 105 may include a utilization metric and/or other higher level input parameters as described above.

According to another embodiment, a work force planning horizon may be input as an input parameter. This parameter may be defined in days, months or years and is not limited as to duration. For example, a work force planning horizon of five years, with calculations based on each individual year may be adopted as an input parameter.

According to another embodiment, input parameters including an input of delivery targets, an input of managerial targets or an input of an economic scenario may be input to define the work force demand. The WFP analytics system 100 may utilize an unlimited number of defined delivery targets, managerial targets and economic scenarios as work force demand drivers.

Three optional economic scenarios are a bull market, an anticipated market and a bear market. This input data 105 are parameters defining a business strategy for different scenarios and also work as a reference point while deriving the productivity metric (i.e., demand drivers) for different sub functions. The drivers may be defined in discussion with the senior leadership and management of the organisation. Managerial targets can be defined with respect to the economic scenarios identified above, such as, for instance, a managerial target for a bull market of 20% growth in Year 1 with 15% growth in subsequent years. Or, for instance, in a bear market, 5% growth in Year 1 with 8% growth in subsequent years.

Delivery targets can be described as the enablers which may enable the organisation to achieve its strategy. Examples of delivery targets could be % revenue growth, number of products launched, number of new markets entered, etc. The WFP analytics system user defines the managerial and the delivery targets with the intent of cascading the targets from an SBU level to a functions level, and possibly a sub-functions level and then to individuals. The WFP analytics system 100 may capture an unlimited number of work force demand drivers. Upon entering the demand drivers, the WFP analytics system user may be requested to add and/or remove demand side drivers, such as revenue, new customers, number of point solutions, etc. Each work force demand driver may be defined, such as total revenue, total volume, total effort etc. Also, any work force demand driver may correspond with another productivity metric such as full-time employment (FTE), revenue/FTE, volume/FTE etc.

According to another embodiment, input parameters including an input of work force supply estimation ground rules, can be input to define the work force supply. The WFP analytics system 100 may define an unlimited number of work force supply estimation ground rules. For instance, one ground rule may be to forecast promotion and attrition numbers based on estimates or past trends based on actual data. Another ground rule, could be WFP analytics system users to input defined variables for promotions and attritions. The ground rules may be defined in discussions with the senior leadership and management of the organisation.

After the input data 105 is received at the processing module 101, according to an embodiment, the analytics module may determine a forecast work force gap as output data 108 by processing the inputs of the definition of the current or projected organisational structure, the current or projected work force, the work force current or projected demand and the current or projected work force supply utilizing the various input parameters. In determining the forecast work force gap, the WFP analytics system 100 utilizes the inputs of the work force and the work force supply as work force supply drivers. The WFP analytics system 100 also utilizes the inputs of the organisational structure and the work force demand as work force demand drivers. The WFP analytics system 100 then performs a gap analysis by subtracting the work force demand drivers from the work force supply drivers to arrive at the determined forecast work force gap. The determined forecast work force gap may be either a deficit or a surplus and at any granularity, such as at an organisational level, a function level, a sub-function level, at a designated position level or at some other level defined by the WFP analytics system user.

According to another embodiment, the analytics module is configured to perform a mapping of the work force to the definition of the organisational structure to determine an output of a current work force gap. The mapping is a placement of all the individual members of the work force into the definition of the organisational structure. The mapping may be based on current or projected data and done at any granularity as described above.

According to another embodiment, the analytics module is configured to determine a cost benefit summary based on a forecasted organisational implementation of the forecast work force gap. The cost benefit summary may quantify a net present value (NPV) of potential future revenues and/or savings to an organisation based on a potential fulfillment of a fulfillment scenario to meet a forecast work force gap. The NPV of the future revenues and/or future savings may be offset against the present costs of the WFP analytics system 100 and/or other present costs and/or an NPV of potential other future costs which may be associated with a fulfillment scenario.

### 3. Screenshots Example

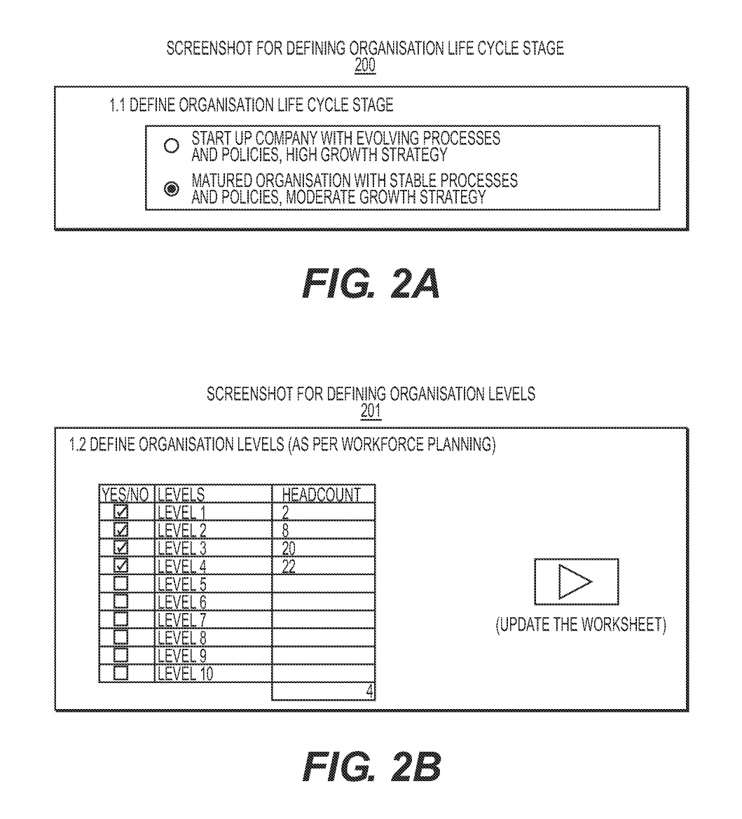

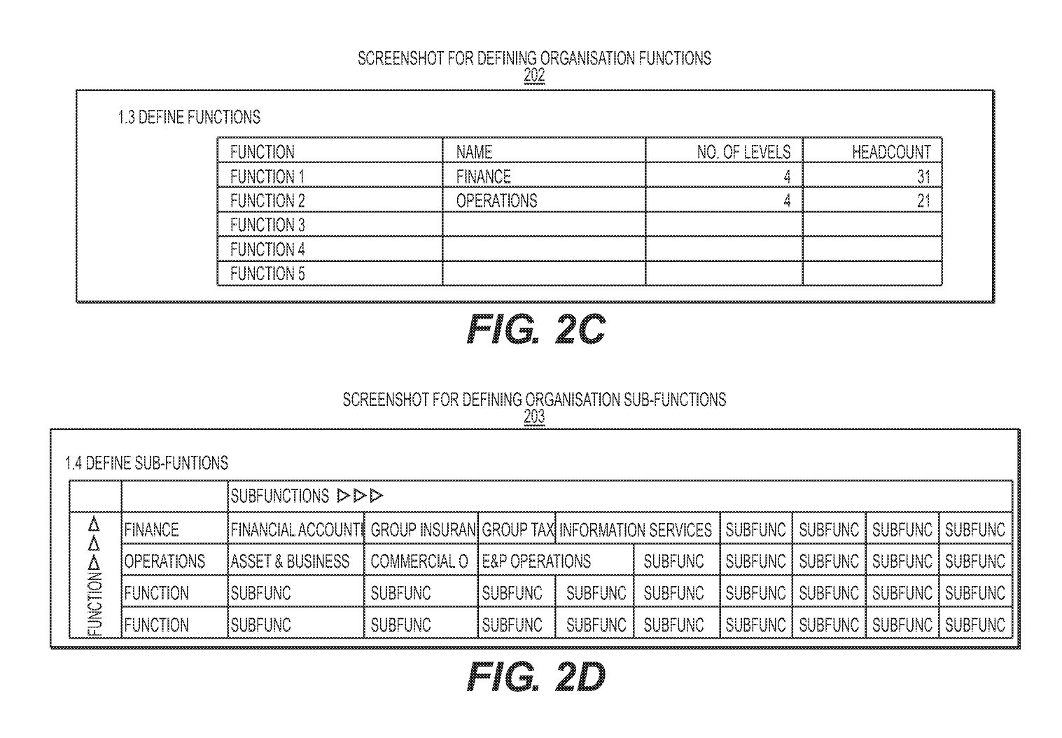

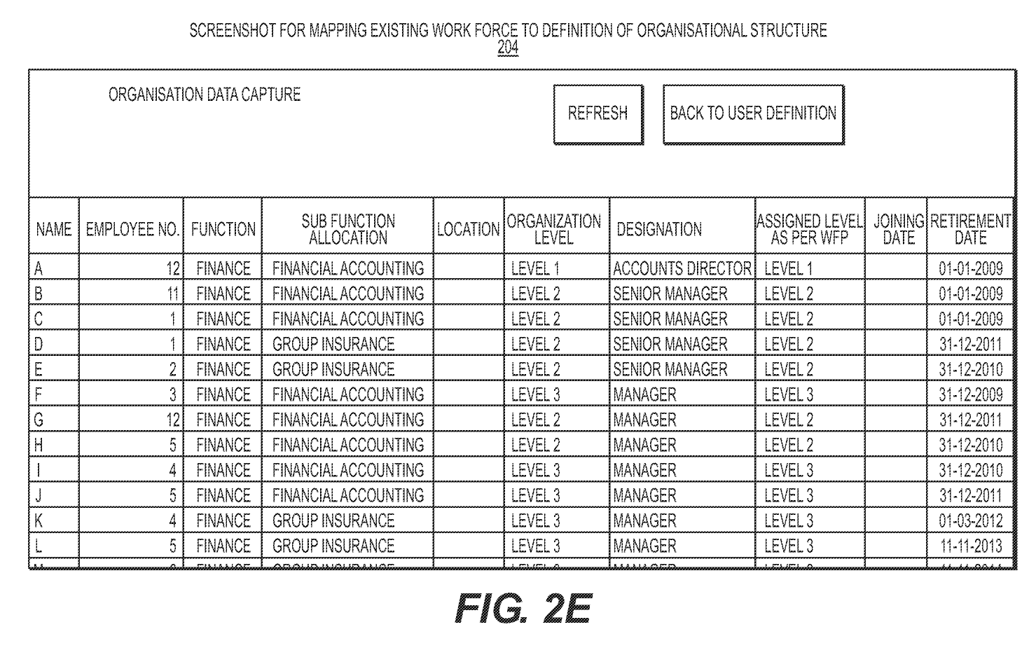

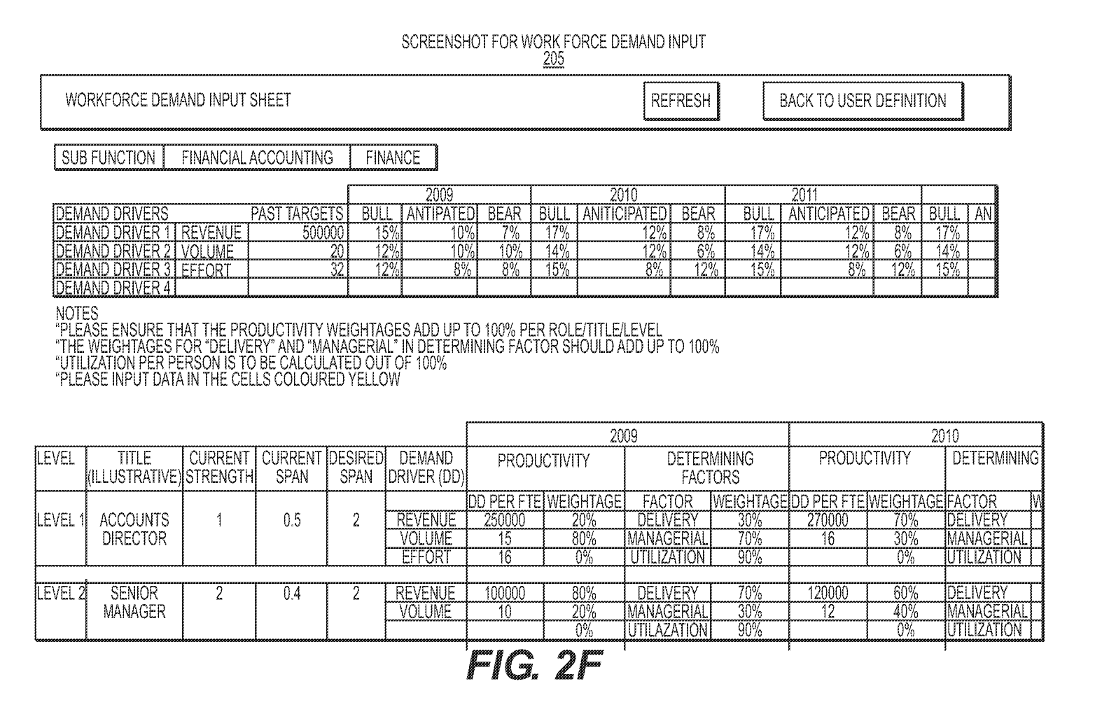

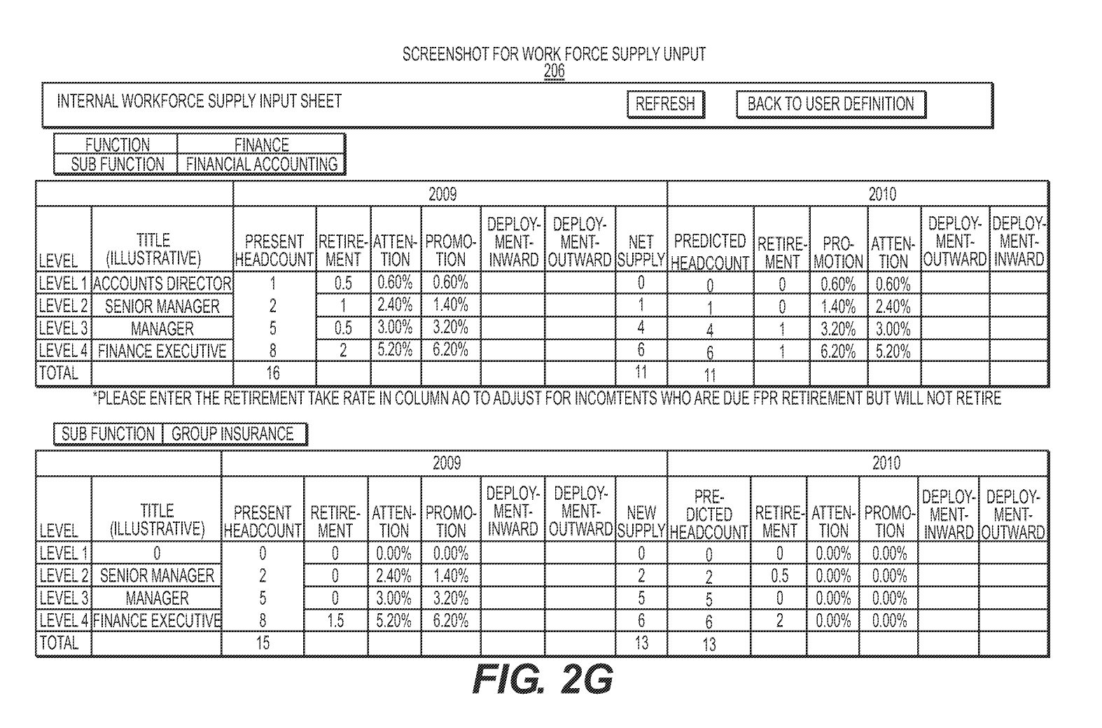

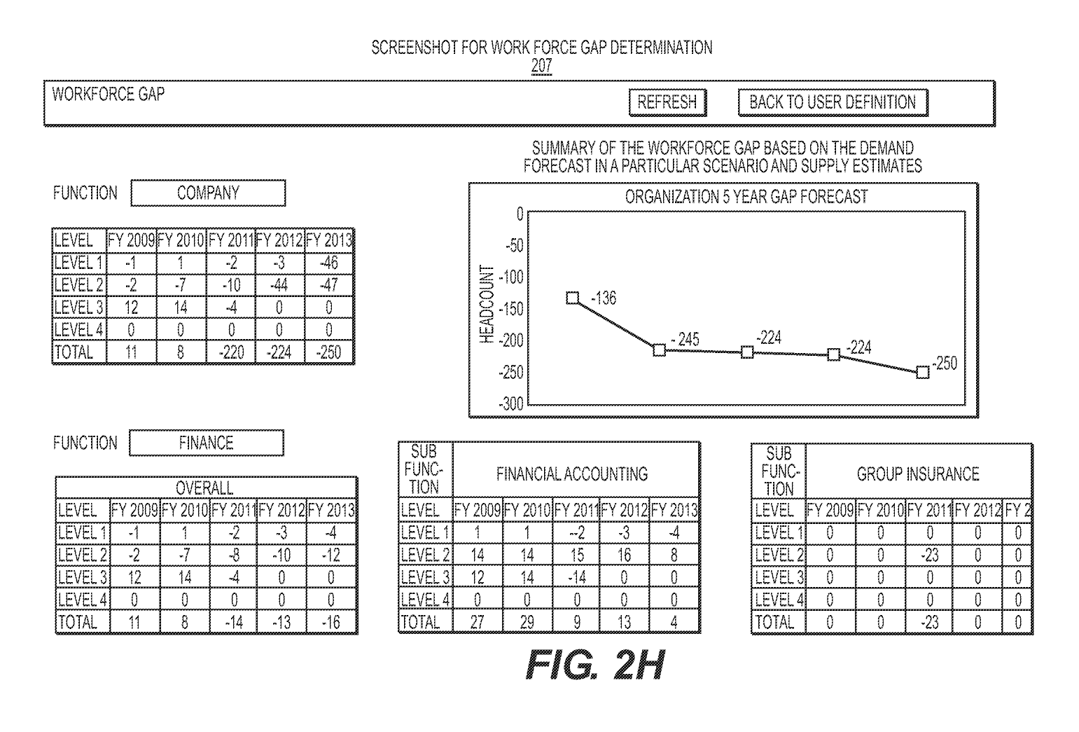

FIGS. 2A through 2H illustrate screenshots that may be generated through the user interface 106 in the WFP analytics system 100. These screenshots 2A through 2H demonstrate an example of determining an output of a forecast work force gap utilizing the WFP analytics system 100. The example is described with respect to the WFP analytics system 100, by way of example and not limitation. This example may be performed in other systems.

FIG. 2A illustrates a screenshot for defining organisation life cycle stage 200. This screen is used to define a parameter for the work force demand. The organisation life cycle stage is selected to define whether the organisation is a startup organisation or a matured company. This assists the WFP analytics system 100 to account for how responsibilities of the employees may change over the years. The input parameter entered may be an estimate as to a percentage of annual change due to movement or changes. In general, this may be higher in a start-up organisation.

FIG. 2B illustrates a screenshot for defining organisation levels 201. In this screen the total numbers of levels across the organisational hierarchy in the organisation are defined. Also, the headcount for each level is ascertained in this step. In this screenshot, the organisation has four levels with a headcount for each level.

FIG. 2C illustrates a screenshot for defining organisation functions 202. In this screen, the different functions along with their respective headcount and number of levels are defined in the screen, finance and operations are the two functions, having four levels each, and the headcount for each function is 31 and 21, respectively.

FIG. 2D illustrates a screenshot for defining organisation sub-functions 203. In this screen, sub functions for each of the functions from the screen in FIG. 2C are defined. For example, in the screen in FIG. 2D, for finance, the sub functions are financial accounting, group insurance, group tax and information services.

FIG. 2E illustrates a screenshot for mapping existing work forces to a definition of organisational structure 204. In this screen, the WFP analytics system 100 captures the work force data of the organisation. The WFP analytics system user may collect the current work force as input data 105 from an organisational ERP database. This downloaded input data 105 may then be mapped with an input data 105 of a definition of the current organisational structure. The display in the user interface 106 breaks down work force member demographic data by functions such as finance, for the organisation.

The stored demographic data may include information such as employee name, employee identification number, sub-function allocation, such as pre sales consultant, solution architect, customer engagement etc., organisational level, organisation designation, an assigned level, joining date, retirement date, previous year performance rating, promotion history, transfer history and job rotation history, and or other demographic data such as career level and grade. The mapping provides for an overview of the structure of the organisation which may be utilized for a validation check of the as-is current organisational structure. The mapping is also a data input 105 for the work force supply, e.g., the current number of personnel by functions for different levels of the organisation. For example, for the finance function level, there are 3 employees, and the mapping can confirm, for example, that there are currently 10 personnel at the organisation.

FIG. 2F illustrates a screenshot for work force demand input 205. In this screen, the WFP analytics system 100 captures input data 105 for the work force demand of the organisation. This screen involves providing inputs in the work force demand input sheet for each function. The screen in FIG. 2F shows a work force demand input sheet for the finance function. The parameter rules input in this screen, for example, may be as follows: productivity weights may add up to 100% per role/title/level; the weights for delivery and managerial in determining factors may add up to 100%; and the utilization metric per person may be calculated out of 100%.

A work force demand input may be based on the exemplary economic scenarios: bull (i.e., a favorable economy for business), anticipated (i.e., a normal or regular economy) or bear (i.e., an economy that is less favorable than normal for business). Business targets define productivity metrics (i.e., demand drivers), which may also be defined at a sub-function level and at a role level. The WFP analytics system 100 allows an unlimited number of demand drivers per function and/or sub function. The WFP analytics system user may select the demand drivers from a pre-defined list or from other sources. Past targets may be utilized as baselines for future forecasts. Future targets may be entered as input 105, automatically, manually and/or after consultation with organisational leadership. The WFP analytics system 100 allows an unlimited number of demand drivers per role. In FIG. 2F, three demand drivers per role are shown.

Examples of work force demand data entry steps are as follows: Select levels which have been defined. Enter a current strength. Enter a current span. Enter a desired span. Select demand drivers. Select productivity. Select demand drivers per FTE. Select weights for the demand drivers, (the sum of all of the demand driver weights sum, in general, may not exceed 100%). Select determining factors (i.e., determining factors refer to the responsibility split of the role between delivery and managerial activities in a role.) Select factors like delivery, managerial and utilization and enter a weight for each. Repeat these entries for each year for the planned forecast and at each level. Follow the entry of the data input 105 as described above. For example, the WFP analytics system 100 may generate reports, such as a report with total demand of employees based on different input data 105 parameters like year, function, sub function, economy type etc. with the demand values. The reports generated may provide for a comparison of demand based on each year, department, level, economy etc. Also, the WFP analytics system user may review a graphical comparison report, based on the different parameters utilized.

FIG. 2G illustrates a screenshot for work force supply input 206. In this screen, the WFP analytics system 100 captures the input data 105 for the work force supply of the organisation. This screen demonstrates input data 105 for a work force supply input for the finance function and the sub functions under it. The steps which may be followed in this data entry can be as follows: The values of a head count for each level, for any particular year, and for any particular function are entered from an organisation mapping. A retirement rate may be calculated based on the actual age of the employee and a defined retirement age adopted for the organisation. A WFP analytics system user may choose to forecast the trends. In this circumstance, the values for attrition rate and promotion rate may be auto populated based on historical data of a prior work force. The WFP analytics system 100 may also predict the future trends based on the same historical data.

FIG. 2H illustrates a screenshot for work force gap determination 207, according to an embodiment. In this screen, a forecast work force gap includes deficits and surpluses shown at different granularity levels, including functions and sub-functions of the organisation. A graphical summary representation for the organisation's five year gap forecast is also shown.

### 4. Methods

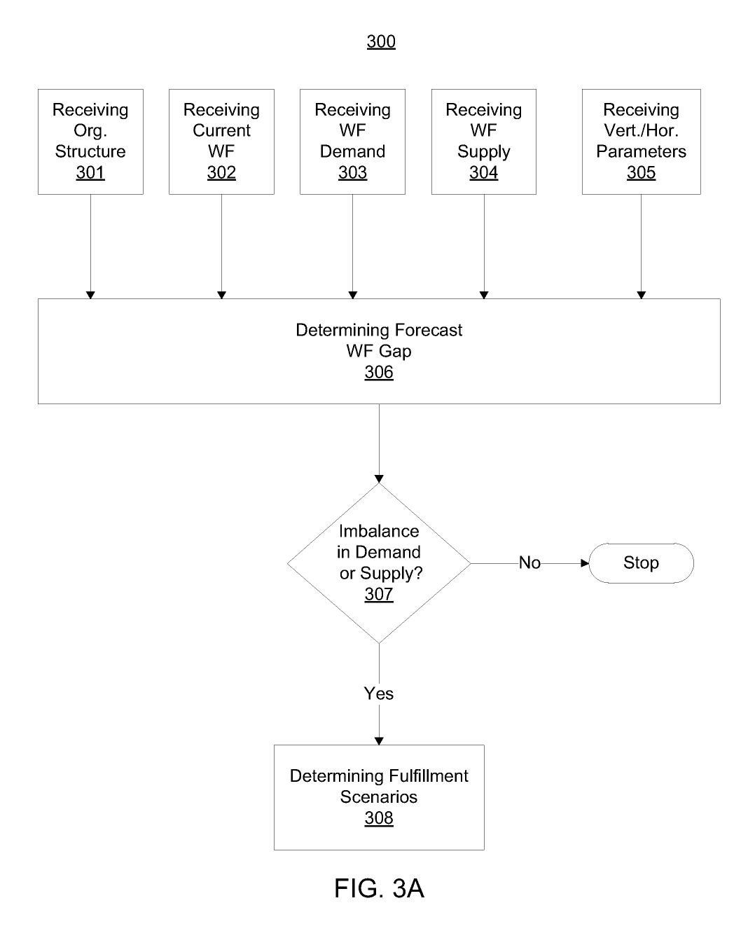

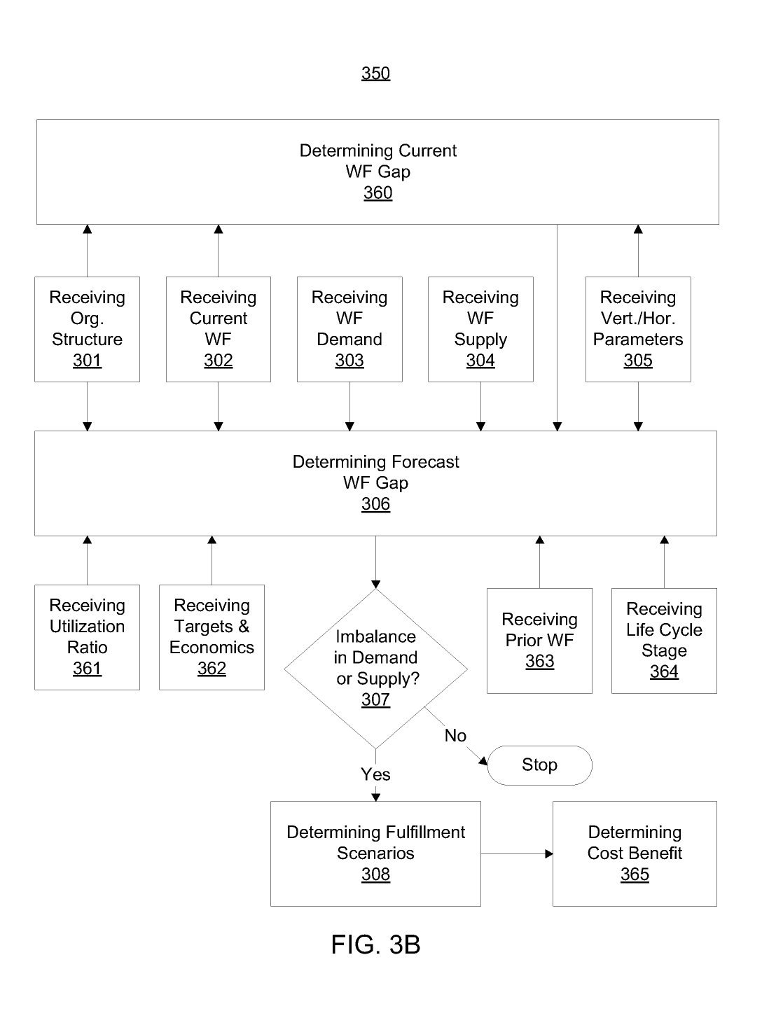

FIGS. 3A and 3B illustrate methods 300 and 350 for performing WFP analytics for an organisation, having a current organisational structure and including a current work force, according to two embodiments. The methods 300 and 350 are described with respect to the WFP analytics system 100, shown in FIG. 1B, by way of example and not limitation, and this method may be performed in other systems.

Referring to FIG. 3A, in the method 300, at step 301 the WFP analytics system 100 receives an input of a definition of the current organisational structure.

At step 302, the WFP analytics system 100 receives an input of a current work force. This may be entered manually, or downloaded, for instance, from an ERP system for the organisation.

At step 303, the WFP analytics system 100 receives an input of a work force demand and the work force demand is different than the current organisational structure. Exemplary input data sources and input parameters as inputs of the work force demand are described above.

At step 304, the WFP analytics system 100 receives an input of a work force supply, and the work force supply is different than the current work force. Exemplary data sources and parameters as inputs of the work force supply are described above.

At step 305, the WFP analytics system 100 receives an input of vertical and/or horizontal input parameters relating to the organisation. The input parameters can be based on horizontal organisational divisions based on different functional areas and/or vertical organisational divisions based on different responsibility levels. The input parameters may instead/also be based on individual work force members having one or more horizontal roles in one or more functional areas, one or more vertical roles in one or more responsibility levels, or a plurality of horizontal and vertical roles.

At step 306, the WFP analytics system 100 determines an output of a forecast work force gap utilizing the inputs of the definition of the current organisational structure, the current work force, the work force demand and the work force supply and one or more other input parameters. The WFP analytics system 100 may utilize the inputs of a current organisational structure and the work force demand as work force demand drivers and the inputs of the current work force and the work force supply as work force supply drivers. The WFP analytics system 100 may then perform a gap analysis by subtracting the work force demand drivers from the work force supply drivers to determine a forecast work force gap. The determined forecast work force gap may be either a deficit or a surplus and at any granularity, such as at an organisational level, a function level, a sub-function level, at a designated position level or at some other level defined by the WFP analytics system user.

At step 306, the WFP analytics system 100 calculates whether any gaps are determined based on the work force demand or the work force supply. This calculation may be performed, for example, for the organisation as a whole, at the function level and/or at the sub-function level or at other granularities. In this calculation, the determined forecast work force gap is divided to show that portion relating to a particular input of the work force demand or the work force supply utilized by the WFP analytics system user. As an example, the portion of the forecast work force gap which may be attributed to the estimation for attrition as a demand driver is shown. Another example can be the portion of the forecast work force gap which may be attributed to the estimation for recruitment as a supply driver being shown. The results delivered through step 306 can be utilized as a validation (i.e. a reality check) on the inputs of the work force demand or the work force supply utilized by the WFP analytics system user.

At step 307, the WFP analytics system 100 is utilized in determining fulfillment scenarios including consideration of the output data 108 from steps 307 and/or 308. For instance, the WFP analytics analysis performed utilizing the WFP analytics system 100 may determine, among other things, that an accounts receivable sub-function in an accounting function of an organisation has a potential deficit of three accounting clerks eighteen months in the future. A fulfillment scenario for this gap determination includes hiring three accounting clerks accounts to the receivable sub-function. The WFP analytics system 100 may be utilized in sending a communication about this information to the human resources department of the organisation, such as via a communications network or an ERP system in the organisation.

Referring to FIG. 3B, in the method 350, this exemplary method is similar but more complex than the method 300 shown in FIG. 3A. In method 350, the steps 301 to 307 shown in FIG. 3B are similar to the steps 301 to 307 in FIG. 3A, and are performed in conjunction with the following additional steps. The purpose of method 350, as compared with method 300, is to incorporate additional input data sources and input parameters as input data 105 for the WFP analytics system 100. By utilizing the additional input data sources and input parameters, the WFP analytics system 100 may determine a forecast work force gap which is more precise and more accurate than a similar WFP analytics analysis performed without the additional input data sources and input parameters, such as the WFP analytics analysis performed in method 300.

For steps 301 to 307, please refer to the description for these steps provided in the method 300 with respect to FIG. 3A.

At step 360, the WFP analytics system 100 determines an output of a current work force gap utilizing the inputs of the definition of the current organisational structure and the current work force. This determination may be utilized in method 350 by the WFP analytics system 100 in step 306 described above.

At step 361, the WFP analytics system 100 receives an input of a definition of a utilization ratio. This input may also be utilized in method 350 by the WFP analytics system 100 in step 306 in step 306 described above.

At step 362, the WFP analytics system 100 receives an input of one or more parameters including an input of delivery targets, an input of managerial targets or an input of an economic scenario. This input may also be utilized in method 350 by the WFP analytics system 100 in step 306 described above.

At step 363, the WFP analytics system 100 receives an input of a prior work force in step 306 described above. This may be entered manually, or downloaded, for instance, from an ERP system for the organisation.

At step 364, the WFP analytics system 100 receives an input of an organisational life-cycle stage in step 306 described above. This may be entered manually, for instance, as an estimate after consultation with leadership in the organisation.

At step 365, the WFP analytics system 100 determines a cost benefit summary based on a forecasted organisational implementation of the forecast work force gap or gaps. The cost benefit summary may quantify a net present value (NPV) of potential future revenues and/or savings to an organisation based on a potential fulfillment of a fulfillment scenario to meet a forecast work force gap. The NPV of the future revenues and/or future savings may be offset against the present costs of the WFP analytics system 100 and/or other present costs and/or an NPV of potential other future costs which may be associated with a fulfillment scenario.

### 5. Computer System for Executing Software

One or more of the steps and functions described herein and one or more of the components of the systems described herein may be implemented as computer code stored on a computer readable medium, which may be a non-transitory computer readable medium such as memory or other types of storage devices. The computer code is executed on a computer system (e.g., the computer system 400 described below), for example, by a processor, application-specific integrated circuit (ASIC), or other type of circuit. The code may exist as software program(s) comprised of program instructions in source code, object code, executable code or other formats.

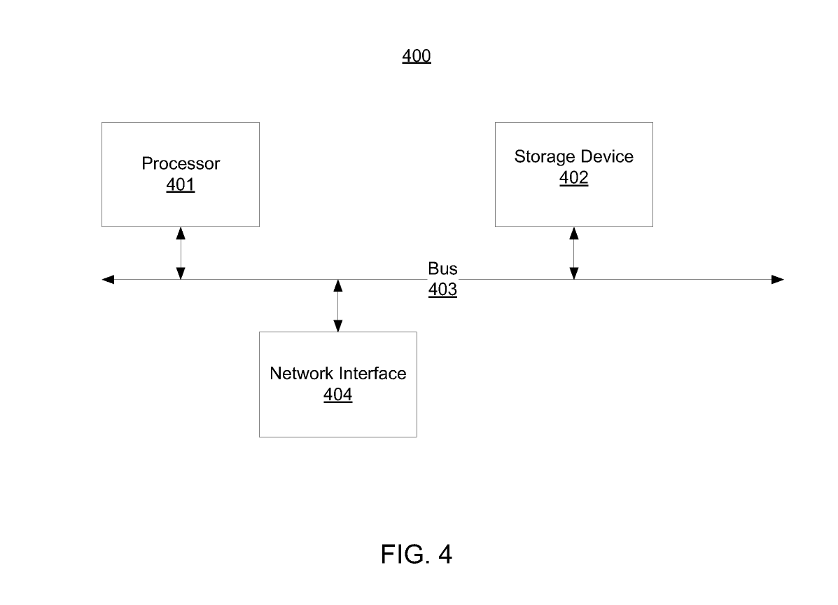

FIG. 4 shows a computer system 400 that may be used as a hardware platform for the payment instruction processing system 100. The computer system 400 may be used as a platform for executing one or more of the steps, methods, and functions described herein that may be embodied as software stored on one or more computer readable storage devices, which are hardware storage devices.

The computer system 400 includes a processor 401 or processing circuitry that may implement or execute software instructions performing some or all of the methods, functions and other steps described herein. Commands and data from the processor 401 are communicated over a communication bus 403.

The computer system 400 also includes a computer readable storage device 402, such as random access memory (RAM), where the software and data for processor 401 may reside during runtime. The storage device 402 may also include non-volatile data storage. The computer system 400 may include a network interface 404 for connecting to a network. It is apparent to one of ordinary skill in the art that other known electronic components may be added or substituted in the computer system 400.

### 6. Technical Effects

Technical effects associated with systems and methods associated with a WFP analytics system, such as WFP analytics system 100, includes the collection of input data 105, the production of output data 108 and an improved user interface 106 giving the user convenience when entering and/or reviewing data regarding different kinds of data fields and parameters associated with performing WFP analytics. Another technical effect is the more economical use of memory and bandwidth in a computer system used within an organisation by reducing the overall intra-organisational communications and resources associated with performing WFP analytics.

This is in contrast with WFP analytics performed manually along more traditional lines, without a WFP analytics system, and involving extensive interactions among organisational units to communicate and deliberate with an organisational human resource department. The WFP analytics system allows faster processing of computations in the organisational computer system, faster communications over the organisations computer network, less system down-time associated with both the organisational computer system and network, and increased management efficiency in managing the work force at an organisation based on utilization of the WFP analytics system. The WFP analytics system thus achieves a minimal load of data processing.

Also, the WFP analytics system provides a technical tool for efficient search, retrieval and evaluation of an organisation's work force plans and records. Also, the arrangement of data fields, menu items and images on a screen in user interface 106 is determined by technical considerations aimed at enhancing the user's ability to manage the technical task of work force planning performance and tracking or planning for changes to work force planning inputs, outputs, estimates, gaps and/or forecasts.

The functions/steps of processing the WFP analytics system data provides information to the user in the form of a technical tool for an intellectual task the user has to master, and hence contributes to the technical solution of a technical problem of efficient search, retrieval and evaluation of an organisations work force planning inputs, outputs, estimates, gaps and/or forecasts. The easily used user interface 106 allows the user to grasp the organisational work force needs faster and more accurately, thus facilitating organisational activity, and thus resulting in an improved, continued man-machine interaction.

Furthermore, the systems and methods described herein are generally described with respect to performing WFP analytics in a corporation or organisation directed to generating profits in the marketplace. However, the system and methods are applicable to performing WFP analytics for other types of organisations, including volunteer projects, charitable foundation, joint ventures between distinct entities and branches or segments of government.

While the embodiments have been described with reference to examples, those skilled in the art are able to make various modifications to the described embodiments without departing from the scope of the embodiments as described in the following claims, and their equivalents.

What is claimed is:

1. A system configured to perform work force planning analytics for an organisation having an organisational structure and a work force, the system comprising:
a processing module configured to receive
input parameters for determining a work force demand, including a definition of the organisational structure and one or more of a productivity metric, a utilization metric, a determining factor metric and a desired span of control metric,
one or more input parameters for determining a work force supply, including an input of the work force;
an analytics module, executed by a processor, configured to determine a forecast work force gap utilizing the input parameters for determining a work force demand and supply; and
a user interface configured to provide a view of the forecast work force gap.

2. The system according to claim 1, wherein one or more of the input parameters for determining a work force demand or supply is based on the presence of a horizontal organisational division between different functional areas and a vertical organisational division between different responsibility levels.

3. The system according to claim 1, wherein one or more of the input parameters for determining a work force demand or supply is based on work force members having a horizontal role in one or more functional areas and one vertical role based on the responsibility levels.

4. The system according to claim 1, wherein the analytics module is configured to perform a mapping of the work force to the definition of the organisational structure to determine a map of the work force.

5. The system according to claim 1, wherein the input parameters for determining a work force demand include one or more of an input of delivery targets, an input of managerial targets and an input of an economic scenario.

6. The system according to claim 1, wherein the input parameters for determining a work force supply include an input of a prior work force.

7. The system according to claim 1, wherein the input parameters for determining a work force supply include an input of an organisational life-cycle stage.

8. The system according to claim 1, wherein the analytics module is configured to determine a cost benefit summary based on a forecast organisational implementation of a fulfillment scenario utilizing the forecast work force gap.

9. The system according to claim 1, wherein the organisational structure and the work force are either current or projected.

10. A system configured to perform work force planning analytics for an organisation having an organisational structure and a work force, the system comprising:
a processor configured to
receive input parameters for determining a work force demand, including a definition of the organisational structure and one or more of a productivity metric, a utilization metric, a determining factor metric and a desired span of control metric,
receive one or more input parameters for determining a work force supply, including an input of the work force, and
determine an output of a forecast work force gap utilizing the input parameters for determining a work force demand and supply; and
a storage device configured to store
the input parameters for determining the work force demand and supply, and
the output of a forecast work force gap; and
a user interface configured to provide a view of the forecast work force gap.

11. A method of performing work force planning analytics for an organisation having an organisational structure and a work force, the method comprising:
receiving input parameters for determining a work force demand, including a definition of the organisational structure and one or more of a productivity metric, a utilization metric, a determining factor metric and a desired span of control metric;
receiving one or more input parameters for determining a work force supply, including an input of the work force;
determining, by a computer, an output of a forecast work force gap utilizing the input parameters for determining a work force demand and supply.

12. The method according to claim 11, wherein one or more of the input parameters for determining a work force demand or supply is based on the presence of a horizontal organisational division between different functional areas and a vertical organisational division between different responsibility levels.

13. The method according to claim 11, wherein one or more of the input parameters for determining a work force demand or supply is based on work force members having a horizontal role in one or more functional areas and one vertical role based on the responsibility levels.

14. The method according to claim 11, wherein the input parameters for determining a work force demand include one or more of an input of delivery targets, an input of managerial targets and an input of an economic scenario.

15. The method according to claim 11, wherein the input parameters for determining a work force supply include an input of a prior work force.

16. The method according to claim 11, wherein the input parameters for determining a work force supply include an input of an organisational life-cycle stage.

17. The method according to claim 11, further comprising determining a cost benefit summary based on a forecast organisational implementation of a fulfillment scenario utilizing the forecast work force gap.

18. The method according to claim 11, the method further comprising performing a mapping of the work force to the definition of the organisational structure to determine a map of the work force.

19. The method according to claim 11, wherein the organisational structure and the work force are either current or projected.

20. A non-transitory computer readable medium storing computer readable instructions that when executed by a computer system perform a method of performing work force planning analytics for an organisation having an organisational structure and a work force, the method comprising:
receiving input parameters for determining a work force demand, including a definition of the organisational structure and one or more of a productivity metric, a utilization metric, a determining factor metric and a desired span of control metric;
receiving one or more input parameters for determining a work force supply, including an input of the work force;
determining, by a computer, an output of a forecast work force gap utilizing the input parameters for determining a work force demand and supply.
